(19) United States
(12) Patent Application Publication
(10) Pub. No.: US 2017/0034301 A1
(43) Pub. Date: Feb. 2, 2017

(54) CACHING STREAMING MEDIA TO USER DEVICES

(71) Applicant: International Business Machines Corporation, Armonk, NY (US)

(72) Inventors: Darryl M. Adderly, Morrisville, NC (US); Jonathan W. Jackson, Durham, NC (US); Ajit Jariwala, Cary, NC (US); Eric B. Libow, Raleigh, NC (US)

(21) Appl. No.: 14/814,489

(22) Filed: Jul. 30, 2015

(51) Int. Cl. H04L 29/08; H04L 29/06

(52) U.S. Cl. CPC H04L 67/327; H04L 65/604; H04L 67/2842

(57) ABSTRACT

A content streaming system automatically caches media simultaneously to multiple user devices in response to a bookmark event to allow a user to subsequently play the automatically stored media on any of the multiple user devices. The content streaming system includes a streaming agent at the content provider that stores a bookmark. The content streaming system provides media content to multiple user devices that have a streaming client to accept the media content over a network.

### BACKGROUND

1. Technical Field

This disclosure generally relates to streaming media to a user device, and more specifically relates to automatically caching streaming media to multiple user devices in response to a bookmark event.

2. Background Art

Consumer use of local networks such as home networks continues to increase. The consumer increasingly desires constant availability of media content on these networks. There are typically multiple devices within the same home that are capable of playing/displaying the same type of content. For example, one can watch an online video on a desktop computer, laptop, tablet computer, a phone or on the TV using a game console, DVD player or other media device. Similarly, one can listen to music either on the computer, a media player or on a dedicated internet-radio box. Each of these devices is capable of downloading content from the interact and playing it, often through a home Wi-Fi network. The content may also be played from in-home devices (e.g., a Digital Living Network Alliance (DLNA) media-player or an MP3 repository).

Generally, when a user device such as described above plays or displays content, the content is downloaded from a service provider over the Internet to that specific device. The media may be cached ahead to some extent to insure uninterrupted play. When the user pauses or interrupts the stream in some way, some services will create a bookmark for the user to come back to the media at the bookmarked location.

### BRIEF SUMMARY

The disclosure and claims herein provide a content streaming system that automatically caches media simultaneously to multiple user devices in response to a bookmark event to allow a user to subsequently play the automatically stored media on any of the multiple user devices. The content streaming system includes a streaming agent at the content provider that stores a bookmark. The content streaming system provides media content to multiple user devices that have a streaming client to accept the media content over a network.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram a computer system with a streaming client as described herein;

FIG. 2 is a simplified block diagram of a content streaming system;

FIG. 3 is a simplified block diagram of a streaming client detecting a bookmark event in a content streaming system;

FIG. 4 is a flow diagram of a method for a content streaming system; and

FIG. 5 is a flow diagram of a specific method for step 420 in FIG. 4.

### DETAILED DESCRIPTION

The disclosure and claims herein relate to a content streaming system that automatically caches media simultaneously to multiple user devices in response to a bookmark event to allow a user to subsequently play the automatically stored media on any of the multiple user devices. The content streaming system includes a streaming agent at the content provider that stores a bookmark. The content streaming system provides media content to multiple user devices that have a streaming client to accept the media content over a network.

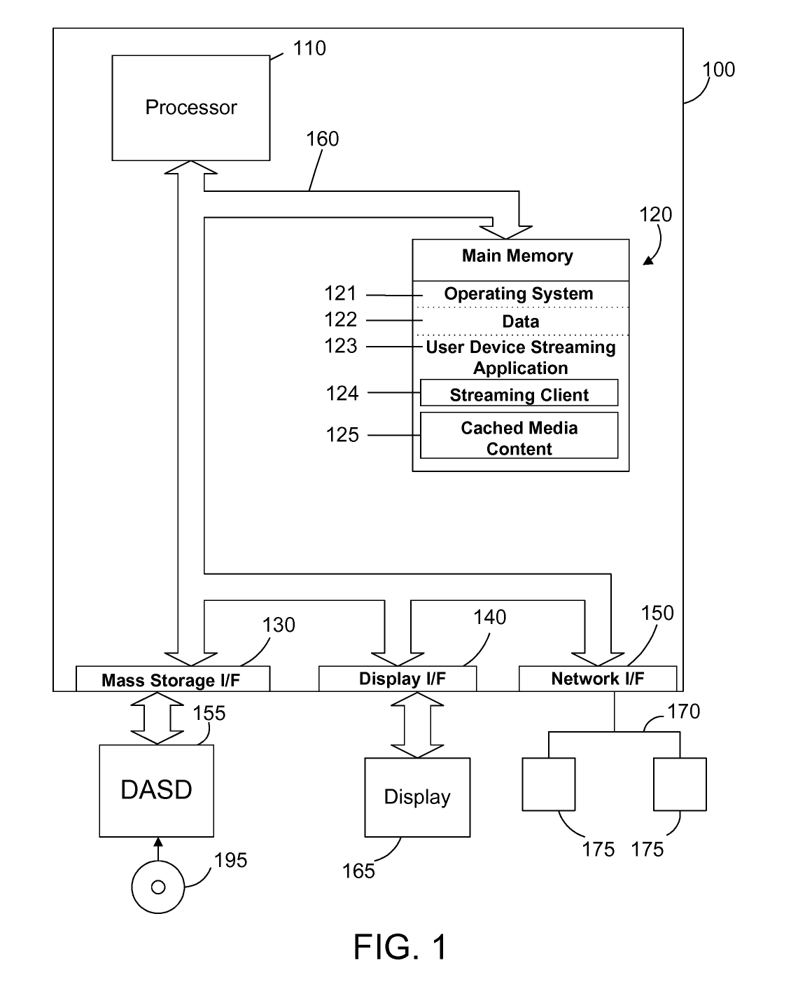

Referring to FIG. 1, a computer system 100 is one suitable implementation of a computer system that includes a content streaming system as described herein. Computer system 100 is a computer which can run multiple operating systems including the IBM i operating system. However, those skilled in the art will appreciate that the disclosure herein applies equally to any computer system, regardless of whether the computer system is a complicated multi-user computing apparatus, a single user workstation, laptop, phone or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices with a computer readable medium, such as direct access storage devices 155, to computer system 100. One specific type of direct access storage device 155 is a readable and writable CD-RW drive, which may store data to and read data from a CD-RW 195. Some devices may have a removable memory card or similar for a direct storage device 155 instead of the CD-RW drive.

Main memory 120 preferably contains an operating system 121. Operating system 121 is a multitasking operating system known in the industry as IBM i; however, those skilled in the art will appreciate that the spirit and scope of this disclosure is not limited to any one operating system. The memory further includes data 122 and a user device streaming application 123 that includes a streaming client 124 and cached media content 125 as described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while operating system 121, data 122, user device streaming application 123, the streaming client 124 and cached media content 125 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 121 and later executes the program instructions that make up the user device streaming application 1238 and the streaming client 124.

Although computer system 100 is shown to contain only a single processor and a single system bus, those skilled in the art will appreciate that a content streaming system may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150, e.g. web client based users.

Network interface 150 is used to connect computer system 100 to other computer systems or workstations 175 via network 170. Network interface 150 broadly represents any suitable way to interconnect electronic devices, regardless of whether the network 170 comprises present-day analog and/or digital techniques or via some networking mechanism of the future. In addition, many different network protocols can be used to implement a network. These protocols are specialized computer programs that allow computers to communicate across a network. TCP/IP (Transmission Control Protocol/Internet Protocol) is an example of a suitable network protocol.

As will be appreciated by one skilled in the art, aspects of this disclosure may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

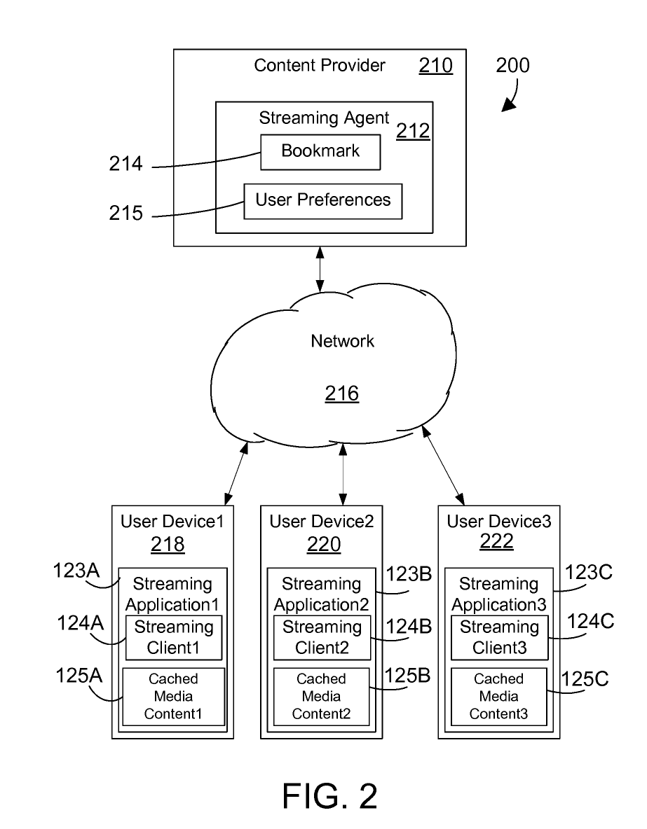

Described herein is a content streaming system 200 that intelligently and automatically caches media simultaneously to multiple user devices in response to detecting a bookmark event. This intelligent and automatic caching enhances the user experience by allowing the user to subsequently play the automatically stored media on any device. FIG. 2 shows an example of a simplified block diagram for the content streaming system 200. The content streaming system 200 includes a content provider 210. The content provider may be a company or organization that handles the distribution of online content such as movies, videos, music or other audio/visual content or files. The content is generally made accessible to users in multiple formats for consumption on multiple platforms. Some popular content providers include Netflix, Hulu, Amazon and networks such as ABC News, Disney and MSNBC.

Again referring to FIG. 2, the content provider 210 includes a streaming agent 212 with a bookmark 214. The streaming agent may also include user preferences 215 as described further below. The streaming agent 212 represents the software on the content provider's systems to stream the content over a network 216 such as the internet. The streaming agent 212 may execute on a computer system such as system 100 shown in FIG. 1. The streaming agent 212 operates similar to prior art streaming agents to stream video to user devices. In addition, as described herein, the streaming agent intelligently and automatically caches media simultaneously to multiple user devices in response to detecting a bookmark event. The streaming agent sends media content over a network 216. The network 216 includes the intern& and may also include a home network or other local area network as described further below. The network 216 communicates with a number of user devices 218, 220, 222. The user devices 218, 220, 222 are each capable of receiving media content over the network 216 in the manner known in the prior art.

The user devices 218, 220, 222 may each represent a computer such as that shown in FIG. 1. Further, each of the user devices 218, 220, 222 may also represent a personal computer, laptop, tablet, phone, DVD player, gaming system or other user device that is capable of providing streaming media. The user devices 218, 220, 222 each have a streaming application 123A, 123B, 123C (collectively referred to as streaming application 123). The streaming applications 123 include a streaming client 124A, 124B, 124C (collectively referred to as streaming client 124) and a cached media content 125A, 125B and 125C (collectively referred to as cached media content 125). The cached media content 125A, 125B and 125C may actually be the same media content stored in each user device but in a different format as described below. The streaming applications, the streaming clients and the cache were introduced as streaming application 123, streaming client 124 and cached media content in FIG. 1. The streaming clients 124 in conjunction with the streaming agent 212 provide the capability of intelligently and automatically caching media simultaneously to the user devices 218, 220, 222 in response to detecting a bookmark event. The streaming application may be any application on the user device that allows a user to use media content sent from the content provider. The streaming client 124 is a portion of the streaming application that detects the bookmark event and communicates with the streaming agent as described below.

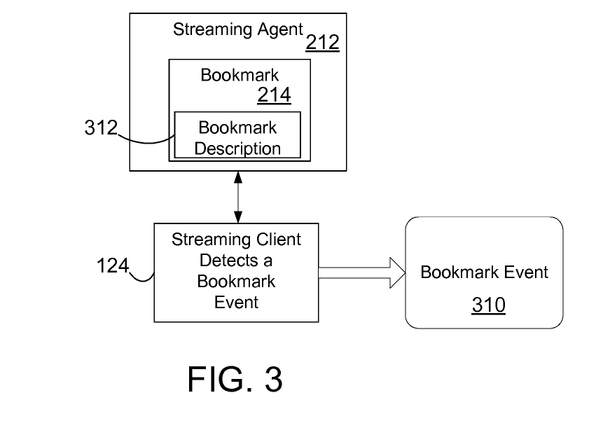

FIG. 3 illustrates a simplified block diagram of a streaming client 124 detecting a bookmark event 310 in a content streaming system. The streaming agent in conjunction with the streaming client first discovers common devices of a user capable of streaming content. The streaming client 124 then detects a bookmark event while streaming media content to a user device. Detection of the bookmark event may be done by any device of the user, including a user device other than the user device that is receiving the streaming media content. In response to detecting the bookmark event 310 the streaming client 124 communicates the occurrence of the bookmark event to the streaming agent 212. The streaming agent 212 then creates a bookmark 214. The bookmark is a time within the streaming media or location of the bookmark event with respect to the streaming media that can be used as a reference point to continue the streaming media. The streaming agent and the streaming client then cache media content 125 into memory of the user device from the bookmark forward to the local memory of multiple user devices to allow the user to continue using content stored in local memory forward from the bookmark and thereby enhance the user experience using media content.

The bookmark 214 shown in FIG. 3 may further include a bookmark description 312. The bookmark description 212 describes the circumstances surrounding the bookmark event to inform the user or use for user preferences described below. For example, the bookmark description 212 may be a textual description such as “loss of connectivity”, or “bookmarked by the user”. The bookmark description may be sent to the user devices and included as metadata with the bookmark event. The bookmark description 312 may be displayed to the user on the user devices. For example, the bookmark description 312 may be displayed to the user on a user device when viewing the bookmark or when the user is “hovering” over the displayed bookmark with a pointer or cursor.

Again referring to FIG. 3, there are various ways for the streaming client 124 to detect a bookmark event 310. A simple case for detecting a bookmark event is detecting when a user performs some action to directly or purposely mark a bookmark event. This could be hitting a “pause” button on a user interface of the user device the user is currently using to use the media content. Alternatively, the user may press a pause button on another user device that is not currently being used to stream content. Thus any user device that was discovered to be associated with the user can actively communicate with the streaming agent to create a bookmark.

Other actions of the user can be interpreted as a bookmark event by the streaming client 124 without purposeful action by the user to create the bookmark. For example, the streaming client 124 could use other capabilities available on the user device to detect when the user no longer is paying attention to the media content and use this determination as a bookmark event. These types of bookmark events could include detecting the user has physically moved away from the user device streaming media content. The detection of the physical movement of the user may include global positioning system (GPS) coordinates and tracking of the user's phone. For example, if the GPS coordinates of the user's phone indicates the user has moved some predetermined number of feet from the location of the user device playing the media content (such as a television or computer) then the streaming client determines that a bookmark event has occurred. Physical movement of the user may also be determined by loss of a Blue-tooth connection of a user device.

Again referring to FIG. 3, the streaming client 124 could also detect a bookmark event without purposeful action by the user where the actions of the user indicate the user is no longer paying attention to the media content. The user can then return to the bookmarked location and continue with the media at a later time on any one of the user's devices. A bookmark event where the user is no longer paying attention to the media content could include receiving a phone call or starting another stream of media on the same or other user device. A streaming client 124 in a user's phone would detect an incoming or outgoing call and report this event to the streaming agent 212. If there is a current media stream to this user, the streaming agent 212 would then create a bookmark 214 and commence caching of the media as described herein.

As introduced with reference to FIG. 2 above, the streaming agent 212 may include user preferences 215. The user preferences may include setting for the streaming agent to customize any features of the content streaming system 200. For example, a user interface associated with the content provider or located within the streaming application 123 of the user device could allow a user to select various features of the content streaming system. User preferences could include setting up how a bookmark event is detected, how much media to cache, a maximum amount of storage, how long cached media content is retained, and what devices to include in the synchronous caching of media content. The user preference may include preferences what to do when the above limits are reached such as erase the oldest media content or not cache additional media content. Another user preference could include password protection for user content with a specific rating to prevent unauthorized viewing by a child for example.

As introduced above, media content is cached to multiple user devices on detection of a bookmark event. The media content is preferably automatically downloaded to other devices of the user. Alternatively, the user may be prompted whether to download the video content. Preferably, the media content is cached to each user device in an appropriate format for each user device. The format of the media content may be set in the user preferences. By caching partially consumed content on devices in different encodings, and taking up different amounts of space, the system can both optimize storage space, replay-ability (not limited to specific network connection as with above solutions), and user experience. Further, the media content can be lazily synched to the various user devices. Lazily synched means that the media content can be downloaded a low priority so as not to disturb other uses of network bandwidth.

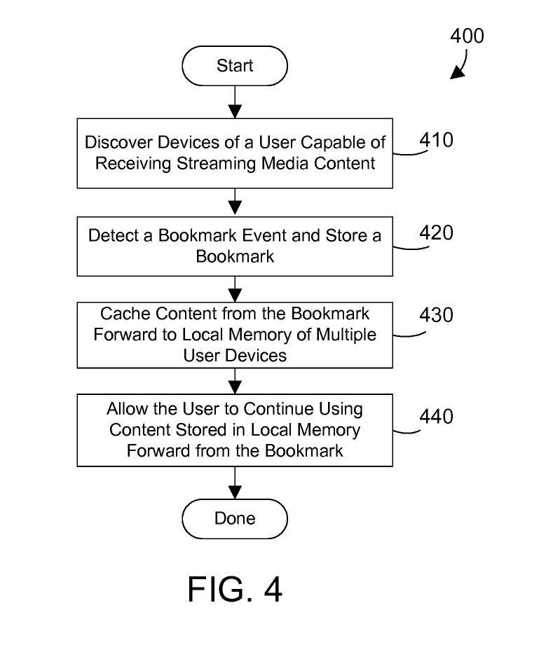

Referring to FIG. 4, a method 400 shows one suitable example for a streaming system to provide an improved user experience. Portions of method 400 are preferably performed by the streaming agent 212 and the streaming client 124. First, discover common devices of a user capable of streaming content (step 410). Detect a bookmark event and store a bookmark (step 420). Then, simultaneously cache content from the bookmark forward to local memory of multiple user devices (step 430). Allow the user to continue using content stored in local memory forward from the bookmark (step 440). The method is then done.

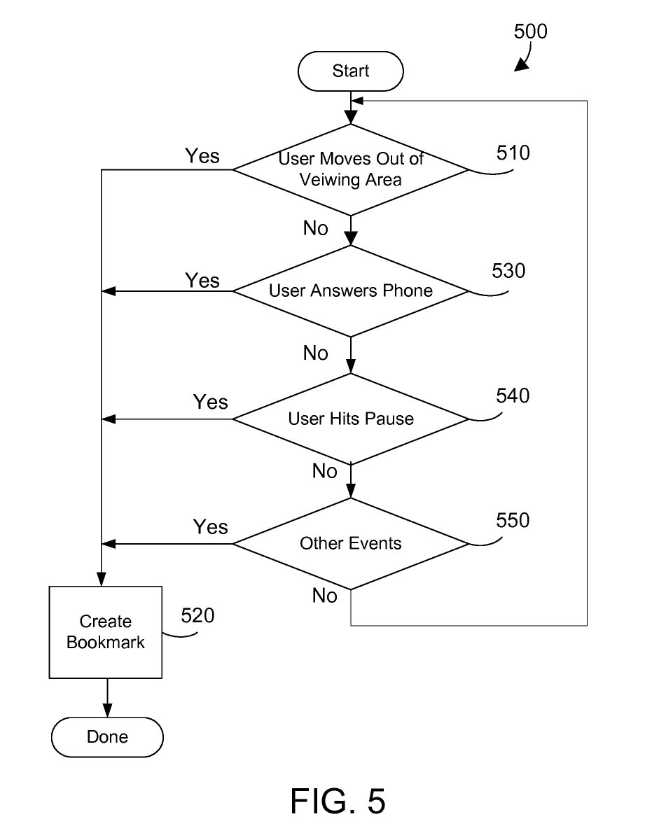

FIG. 5 shows one suitable example of a method 500 for a streaming system to detect a bookmark event. Method 500 thus shows a suitable method for performing step 420 in method 400. First, detect if a user moves out of a viewing area (step 510). If a user is detected moving out of a viewing area (step 510=yes) then create a bookmark at the current time (step 520). If the user is not detected moving out of the viewing area (step 510=no) then detect if a user answers a call on a discovered device (step 530). If a user answers a call on a discovered device (step 530=yes) then go to step 520. If the user is not detected answering a call (step 530=no) then detect if a user hits pause (step 540). If a user hits pause (step 540=yes) then go to step 520. If a user is not detected hitting pause (step 540=no) then check for other bookmark events (step 550). If there are other bookmark events (step 550=yes) then go to step 520. If there are no other bookmark events (step 550=no) then return to step 510 and repeat.

The disclosure and claims herein relate to a content streaming system that provides an improved user experience by automatically caching media simultaneously to multiple user devices in response to a bookmark event to allow a user to subsequently play the automatically stored media on any of the multiple user devices.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1-10. (canceled)

11. A computer-implemented method executed by at least one processor for caching media content, the method comprising:
discovering a plurality of user devices of a user capable of receiving streaming media content;
detecting a bookmark event on a first user device of the plurality of user devices and storing a bookmark while receiving media content from a content provider;
caching media content from the bookmark forward to local memory of the plurality of user devices; and
allowing a user to continue the cached content stored in the local memory forward from the bookmark on the plurality of user devices.

12. The method of claim 11 wherein the media content cached to the plurality of user devices is in a format determined specifically for each user device.

13. The method of claim 11 wherein the bookmark event is the user moving out of a viewing area of the second user device.

14. The method of claim 13 wherein the user is determined to have moved out of the viewing area using a change in global positioning system coordinates on the first user device.

15. The method of claim 13 wherein the user is determined to have moved out of the viewing area by detecting movement of the first user device using network communication.

16. The method of claim 11 wherein the bookmark event is detected by the user answering a phone call on the first user device.

17. The method of claim 11 wherein the bookmark event is detected by the user hitting a pause button on the second user device.

18. The method of claim 11 wherein the bookmark event is detected by the user hitting a pause button on the first user device.

19. The method of claim 11 further comprising
providing a user interface for the user to select download preferences for the plurality of user devices; and
wherein the download preferences allow the user to select a low priority to cache the media content to the plurality of user devices.

20. A computer-implemented method executed by at least one processor for caching media content, the method comprising:
discovering a plurality of user devices of a user capable of receiving streaming media content;
providing a user interface to allow the user to select download preferences for the plurality of user devices;
detecting a bookmark event on a first user device of the plurality of user devices and storing a bookmark while receiving media content from a content provider on a second user device of the plurality of user devices, wherein the bookmark event is the user moving out of a viewing area of the second user device;
caching media content according to the download preferences from the bookmark forward to local memory of the plurality of user devices including the first user device and the second user device, wherein the media content cached to the plurality of user devices is in a format determined specifically for each user device; and
allowing a user to continue the cached content stored in the local memory forward from the bookmark on the plurality of user devices.
